(19) United States
(12) Patent Application Publication
(10) Pub. No.: US 2015/0066582 A1
(43) Pub. Date: Mar. 5, 2015

(54) Methods, Systems, and Graphical User Interfaces for Customer Relationship Management

(71) Applicant: Pipelinersales Corporation, Marina Del Rey, CA (US)

(72) Inventors: Nikolaus Kimla, Pacific Palisades, CA (US); Martin Trnovec, Bratislava-Petrzalka (SK); Milos Krocian, Bratislava-Petrzalka (SK); Adrián Zvara, Bratislava-Petrzalka (SK)

(73) Assignee: Pipelinersales Corporation, Marina Del Rey, CA (US)

(21) Appl. No.: 14/015,734

(22) Filed: Aug. 30, 2013

(51) Int. Cl. G06Q 30/02; G06F 3/0484; G06F 3/0482; G06Q 10/06

(52) U.S. Cl. CPC G06Q 30/0201; G06Q 10/06393; G06F 3/04842; G06F 3/0482
USPC 705/7.29

(57) ABSTRACT

A method is performed at an electronic device with a display. The method includes displaying a first graphical user interface for customer relationship management that includes a first region corresponding to a first sales phase and a second region corresponding to a second sales phase. The first sales phase is associated with a first progress threshold and the second sales phase is associated with a second progress threshold. The device displays a first representation of a first sales opportunity within the first region, the first representation being associated with a first progress metric of the first sales phase. The device displays a first indication of the first progress metric with respect to the first progress threshold.

### TECHNICAL FIELD

The invention relates generally to customer relationship management systems and methods and in particular to software-based systems, methods, and graphical user interfaces for providing customer relationship management.

### BACKGROUND

Conventional customer relationship management (CRM) tools represent a tremendous technological opportunity to organize, automate, and synchronize sales, marketing, customer service, and technical support. CRM tools, however, are notorious for their failed adoption within organizations and/or their fragmented and partial use when they are adopted. By some estimates, billions of dollars have been spent by companies on CRM tools and systems that are not being used, with less than 40% of such companies having adoption rates above 90%.

The failed adoption of CRM tools is generally a matter of company executives being unable to inspire their staffs (e.g., salespeople) to adopt the tools. A major reason for this end-user adoption problem is that conventional CRM tools are top-down instruments. Conventional CRM tools are intended to hold the salesperson accountable to those above, rather than to enable the salesperson to succeed as an entrepreneur. Too often, salespeople feel that CRM tools turn the focus of their jobs to data collection and data management without providing technological assistance to their sales processes. Consequently, salespeople tend to view CRM tools as being designed for executives rather than as tools that can help them in their sales.

The quality of a sales organization stems from a team of salespeople actively preparing and building customer relationships based on information. Selling means knowledgably interacting with potential partners, rather than engaging in unlimited or abstract data collection. Thus, there is a need for CRM tools that unleash the potential of good salespeople by collecting information that helps build such relationships. Furthermore, there is a need for CRM tools that provide the salespeople with latitude in terms of the types of information collected and the manner through which it is presented, so that the inspired salesperson may mold such a tool to his or her unique situation, thereby linking bottom-up sales expertise with top-down goals and needs of company executives.

### SUMMARY

There is a need for customer relationship management (CRM) tools that are engaging and convenient for salespeople while meeting the information technology needs of company executives.

To this end, in accordance with some implementations, a method is performed at an electronic device with a display. The method includes displaying a first graphical user interface for customer relationship management that includes a first region corresponding to a first sales phase and a second region corresponding to a second sales phase. The first sales phase is associated with a first progress threshold and the second sales phase is associated with a second progress threshold. The device displays a first representation of a first sales opportunity within the first region, the first representation being associated with a first progress metric of the first sales phase. The device displays a first indication of the first progress metric with respect to the first progress threshold.

In some implementations, the first indication is displayed within or adjacent to the first representation. In some implementations, the first indication is color coded such as to be displayed with a first color when the first progress metric is less than or otherwise does not satisfy the first progress threshold and a second color when the first progress metric is greater than or otherwise satisfies the first progress metric.

In some implementations, the first sales phase and the second sales phase are user-defined.

In some implementations, the first progress threshold and the second progress threshold are user-defined.

In some implementations, the device receives a first user input. In response to the first user input, the device displays a second graphical user interface. The second graphical user interface displays a second indication of the first progress metric with respect to the first progress threshold. The second indication is visually distinct from the first indication. In some implementations, the second indication comprises a bar graph.

In some implementations, the device receives a second user input. In response to the second user input, the device moves the first representation from the first region to the second region. The device also discontinues display of the first indication of the first progress metric with respect to the first progress threshold, and instead displays a third indication of a second progress metric of the second sales phase with respect to the second progress threshold. In some implementations, the second user input is a drag-and-drop user input.

In some implementations, the first progress metric is a measure of time spent by the first representation in the first region, and the second progress metric is a measure of time spent by the first representation in the second region.

In some implementations, the device receives a third user input. In response to the third user input, the device adds a second representation corresponding to a second sales opportunity to the first region. In some implementations, the third user input is a request to copy the first representation.

To address the need for customer relationship management (CRM) tools that are engaging and convenient for salespeople while meeting the information technology needs of company executives, in accordance with some implementations, another method is performed at an electronic device with a display. The method includes calculating a first sum over each sales opportunity in a plurality of sales opportunities. For each respective sales opportunity in the plurality of sales opportunities, the first sum includes a product of a monetary amount associated with the respective sales opportunity and a likelihood of success associated with a respective sales phase of the respective sales opportunity. The device displays a graphical user interface for customer relationship management, the graphical user interface including a display of information corresponding to the first sum.

In some implementations, the likelihood of success associated with the respective sales phase of each respective sales opportunity is user-defined.

In some implementations, the information corresponding to the first sum is displayed relative to a user-defined goal.

In some implementations, the device receives a first user input. In response to the first user input the device discontinues display of the information corresponding to the first sum, and displays information corresponding to a second sum. The second sum is calculated by summing over each sales opportunity in the plurality of sales opportunities. For each respective sales opportunity in the plurality of sales opportunities, the second sum includes the product of a likelihood of success associated with the respective sales opportunity and a monetary amount associated with the respective sales opportunity.

In some implementations, the device calculates a third sum. The third sum is calculated by summing over each sales opportunity in the plurality of sales opportunities. For each respective sales opportunity in the plurality of sales opportunities, the third sum includes the product of a likelihood of success associated with a respective sales phase of the respective sales opportunity, a likelihood of success associated with the respective sales opportunity, and a monetary amount associated with the respective sales opportunity.

In some implementations, the likelihood of success associated with each respective sales opportunity is user-defined.

In some implementations, the device calculates a fourth sum. The fourth sum is calculated by summing over each sales opportunity in the plurality of sales opportunities. For each respective sales opportunity in the plurality of sales opportunities, the fourth sum includes a monetary amount associated with the respective sales opportunity.

In some implementations, the device receives a second user input. In response to the second user input, the device display a second graphical user interface including display of two or more of: information corresponding to the first sum, information corresponding to the second sum, information corresponding to the third sum, and information corresponding to the fourth sum.

### BRIEF DESCRIPTION OF THE DRAWINGS

FIG. 1 is a diagram of a client-server environment for customer relationship management, in accordance with some implementations.

FIG. 2 is a block diagram illustrating a customer relationship management server system, in accordance with some implementations.

FIG. 3 is a block diagram illustrating a client device, in accordance with some implementations.

FIGS. 4A-4I illustrate user interfaces for customer relationship management, in accordance with some implementations.

FIGS. 5A-5C are flow diagrams illustrating a method of manipulating representations of sales opportunities within a customer relationship management environment, in accordance with some implementations.

FIGS. 6A-6B are flow diagrams illustrating a method of projecting a value associated with a plurality of sales opportunities within a customer relationship management environment, in accordance with some implementations.

Like reference numerals refer to corresponding parts throughout the drawings.

### DESCRIPTION OF EMBODIMENTS

While conventional CRM tools ignore the key factor for success—the end-user—the methods, systems, and graphical user interfaces (collectively “CRM tools”) described in the embodiments of the present disclosure have been developed from the end-user's perspective. More specifically, the CRM tools described herein give the salesperson the decision-making freedom needed to achieve the best results under the best conditions, opening the way to planning and control. To that end, a salesperson can plan their opportunities based on their work process and also shape their risk accordingly. This ability increases motivation and sales success. Similarly, a company for whom the salesperson works can depict, for example, all of the salesperson's (or a sales team's) sales opportunities and plan accordingly, meaning that risk and challenges are identified and appropriate steps can be taken on time.

Unlike conventional CRM tools that involve an unsatisfactory amount of effort, the CRM tools described herein introduce a graphical user interface (GUI) with an intuitive, playful approach. In accordance with some implementations, the GUI gives an overview of current sales opportunities (e.g., using the forecasting metrics described below) to assist both the individual users and company management in making business decisions. In other words, the GUI encompasses the autonomy of the salespeople as well as the control and monitoring requirements of the company.

In accordance with some implementations, the GUI is designed around the concept of a sales “pipeline,” which displays sales opportunities in user-defined regions corresponding to different phases of the sales process. Users can define the regions based on their “boots-on-the-ground” understanding of what makes sense given their unique sales process. For example, consider a situation where a contractor vies for government contracts. The government may solicit initial bids from several contractors and subsequently grant a contract to one of the contractors following several rounds of review. User-defined regions can be established within the GUI to include regions that correspond to, respectively, an “Initial Bid” phase, a “Stage 1” phase, a “Stage 2” phase, and so on. The GUI provides an intuitive and convenient manner through which to “promote” a sales opportunity (e.g., the potential contract) from one phase to the next. For example, in some implementations, a user can drag-and-drop the sales opportunity from the “Initial Bid” phase region to the “Stage 1” phase region, once it has become apparent that the contractor's bid has advanced past the initial bid phase.

As used herein, the term “sales opportunity” may be construed to mean any opportunity that a party has to provide goods and/or services to another party.

To address the issue of burdensome data entry requirements that conventional CRM tools place on salespeople, some implementations provide features that alleviate repetitive tasks. These features include the ability to copy and archive sales opportunities. Continuing with the example of the contractor above, the contractor may have the opportunity to win several similar contracts. It does not make sense, in such circumstances, to require the salesperson to start from scratch each time a sales opportunity (e.g., a potential contract) is to be created within the CRM tool. Instead, some implementations described herein provide the salesperson with the ability to copy an existing sales opportunity (e.g., by selecting a representation of the sales opportunity within the GUI and entering a command such as Control-d on the keyboard). The salesperson must then edit only those details of the new sales opportunity that differ from the existing sales opportunity.

Likewise, in some circumstances, sales opportunities that once appeared “lost” are, in fact, revived. For example, consider a construction company that is in negotiations with a hospital to build a new wing of the hospital. The negotiations may stall when the hospital's financial outlook appears bleak, but be revived several months later after the hospital's financial outlook improves. While conventional CRM tools require the user to delete and recreate sales opportunities in this situation, some embodiments described herein allow the user to archive sales opportunities. Moreover, the embodiments described herein provide convenient and intuitive ways to re-instate archived sales opportunities when they become relevant again.

To address the control and monitoring requirements of the company, some implementations described herein provide a number of forecasting metrics as well as features to sort through sales opportunities, e.g., according to specific salespeople, sales groups, the entire company, etc. As an example, the forecasting metrics include summing monetary amounts over a plurality of sales opportunities. The plurality of sales opportunities can be defined in a number of ways, for example, as those sales opportunities that result from the aforementioned sorting operation. In some implementations, each sales opportunity in the plurality of sales opportunities is weighted by a user-defined likelihood of success of the respective phase of the sales opportunity. In some implementations, each sales opportunity in the plurality of sales opportunities is weighted by a user-defined likelihood of success for that particular sales opportunity. These features allow the company management (or the salesperson) to quickly and easily determine progress, for example, relative to a yearly or quarterly goal.

To this end, various methods, servers, client devices, and graphical user interfaces for customer relationship management are provided, examples of which are illustrated in the accompanying drawings. In the following detailed description, numerous specific details are set forth in order to provide a thorough understanding of the present disclosure and the described embodiments herein. However, embodiments described herein may be practiced without these specific details. In other instances, well-known methods, procedures, components, and mechanical apparatus have not been described in detail so as not to unnecessarily obscure aspects of the embodiments.

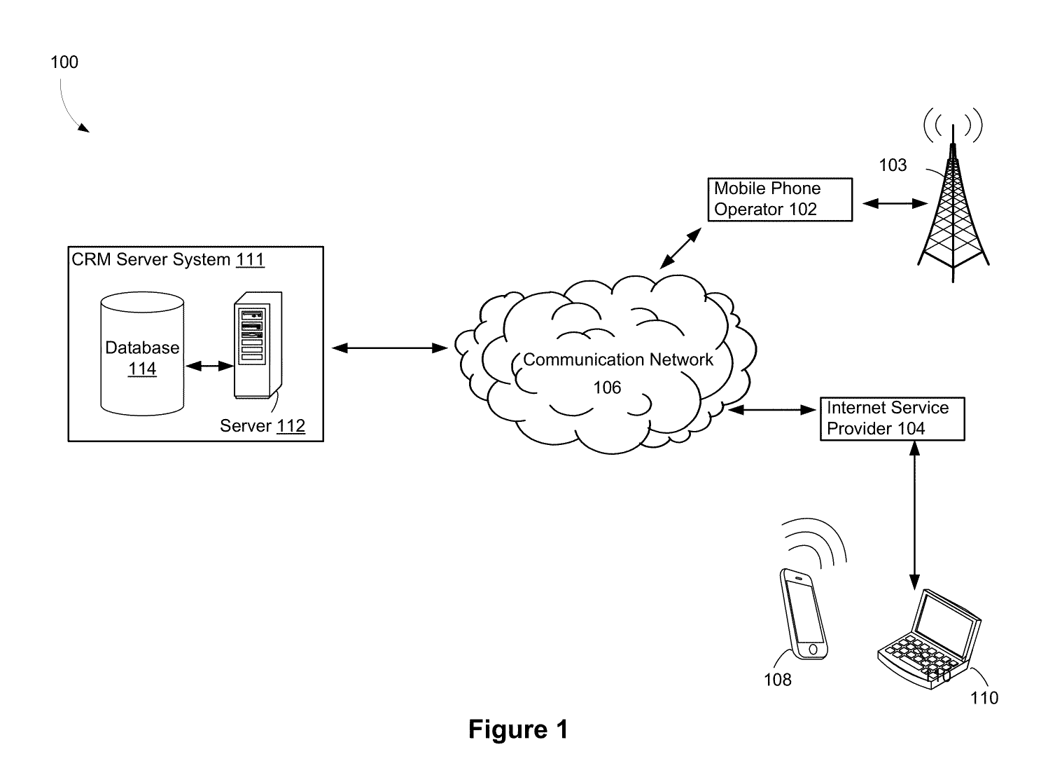

FIG. 1 is a diagram of a client-server environment 100 for customer relationship management, in accordance with some implementations. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes one or more mobile phone operators 102, one or more internet service providers 104, and a communications network 106.

The mobile phone operator 102 (e.g., wireless carrier), and the Internet service provider 104 are capable of being connected to the communication network 106 in order to exchange information with one another and/or other devices and systems. Additionally, the mobile phone operator 102 and the Internet service provider 104 are operable to connect client devices to the communication network 106 as well. For example, a smart phone 108 is operable with the network of the mobile phone operator 102, which includes for example, a base station 103. Similarly, for example, a laptop computer 110 (or tablet, desktop, smart television, workstation or the like) is connectable to the network provided by an Internet service provider 104, which is ultimately connectable to the communication network 106.

The communication network 106 may be any combination of wired and wireless local area network (LAN) and/or wide area network (WAN), such as an intranet, an extranet, including a portion of the Internet. It is sufficient that the communication network 106 provides communication capability between client devices (e.g., smart phones 108 and personal computers 110) and servers. In some implementations, the communication network 106 uses the HyperText Transport Protocol (HTTP) to transport information using the Transmission Control Protocol/Internet Protocol (TCP/IP). HTTP permits a client device to access various resources available via the communication network 106. However, the various implementations described herein are not limited to the use of any particular protocol.

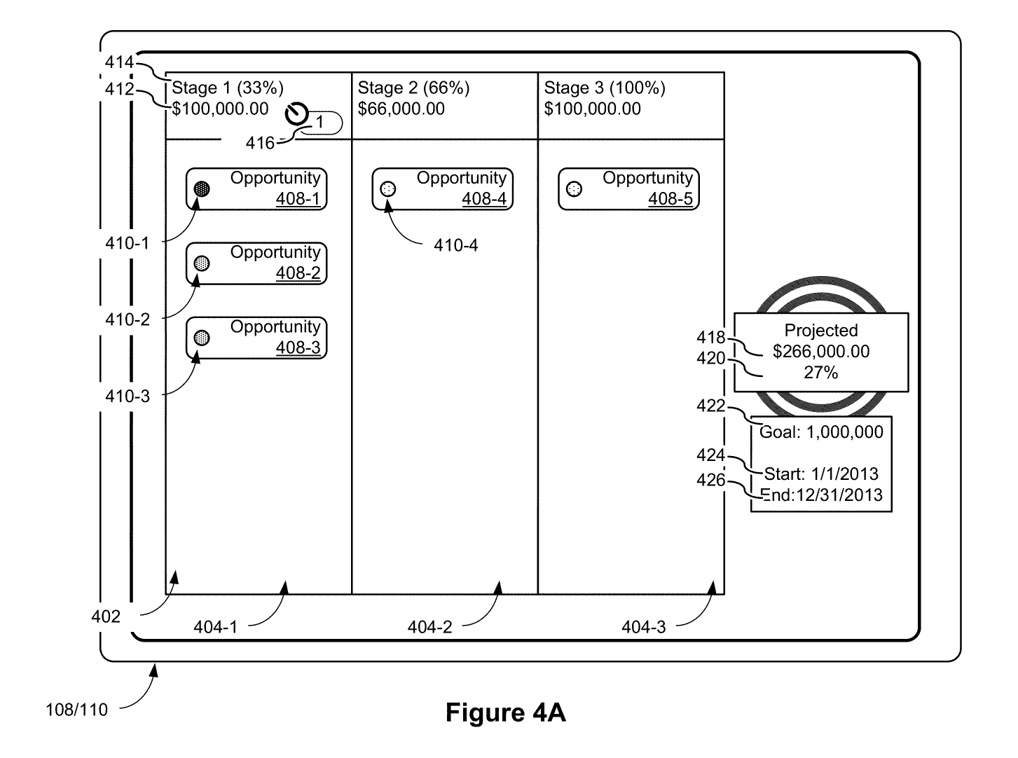

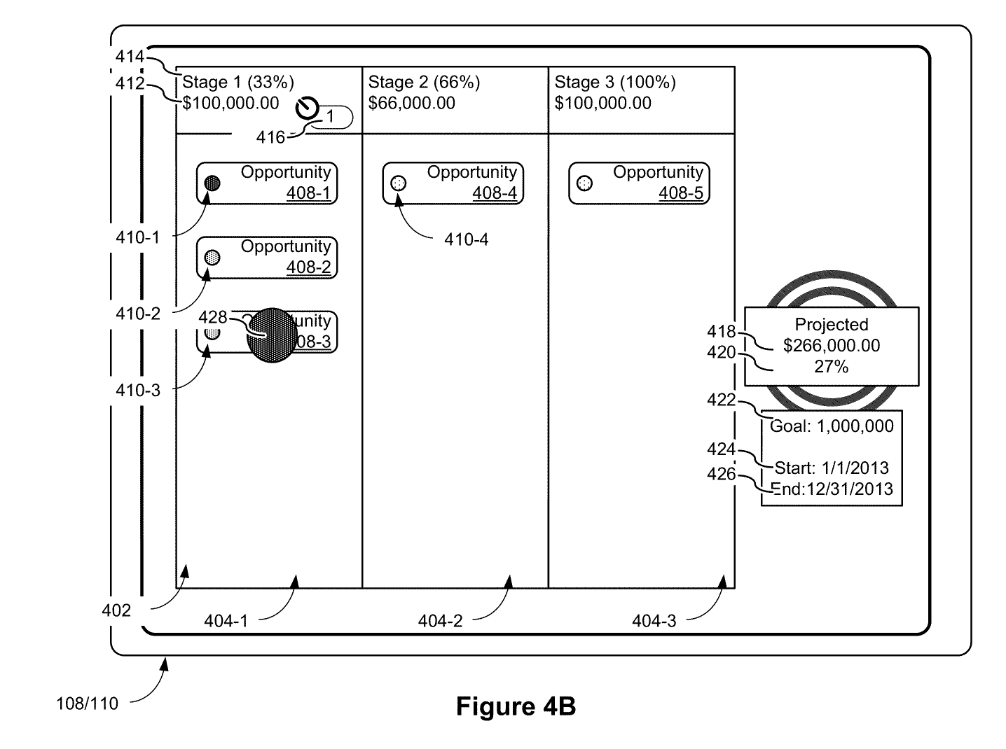

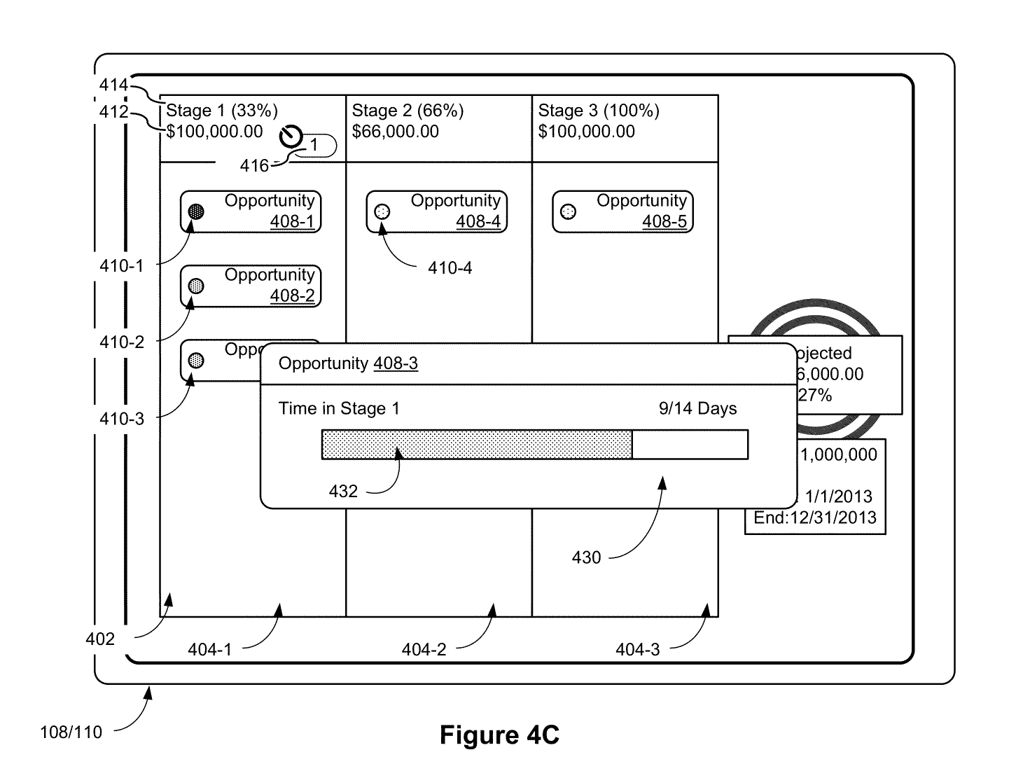

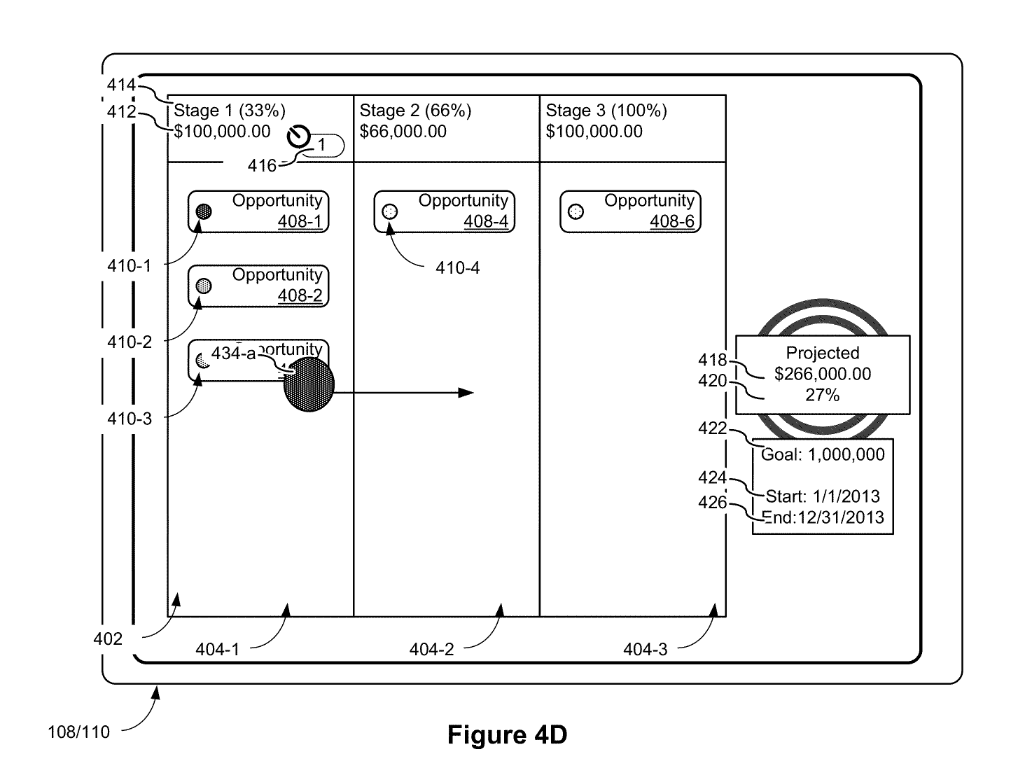

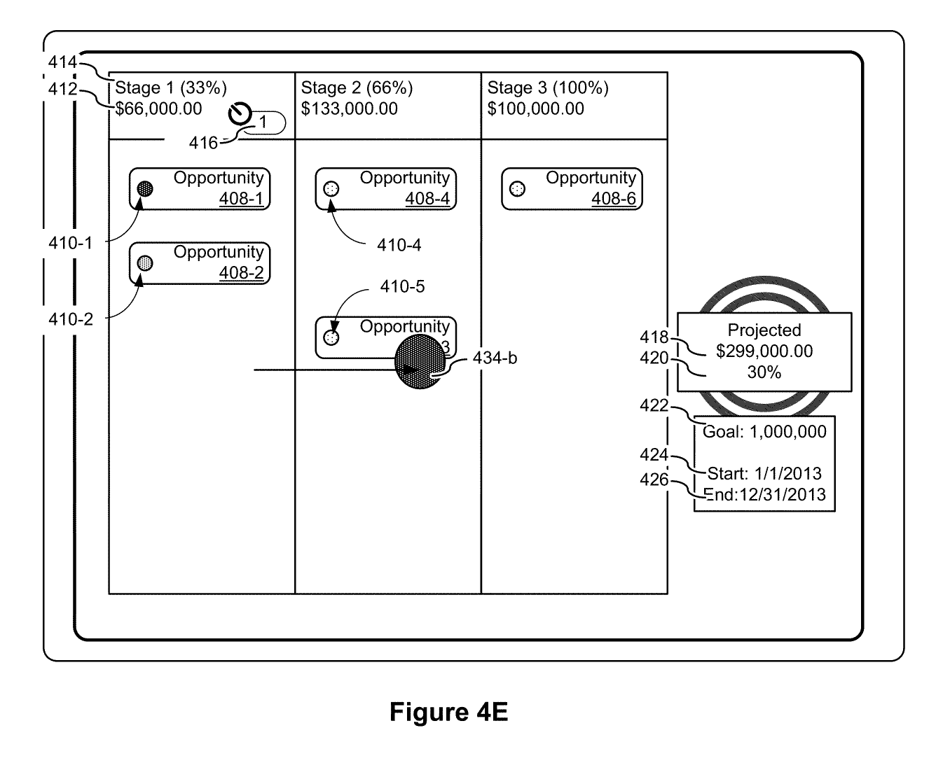

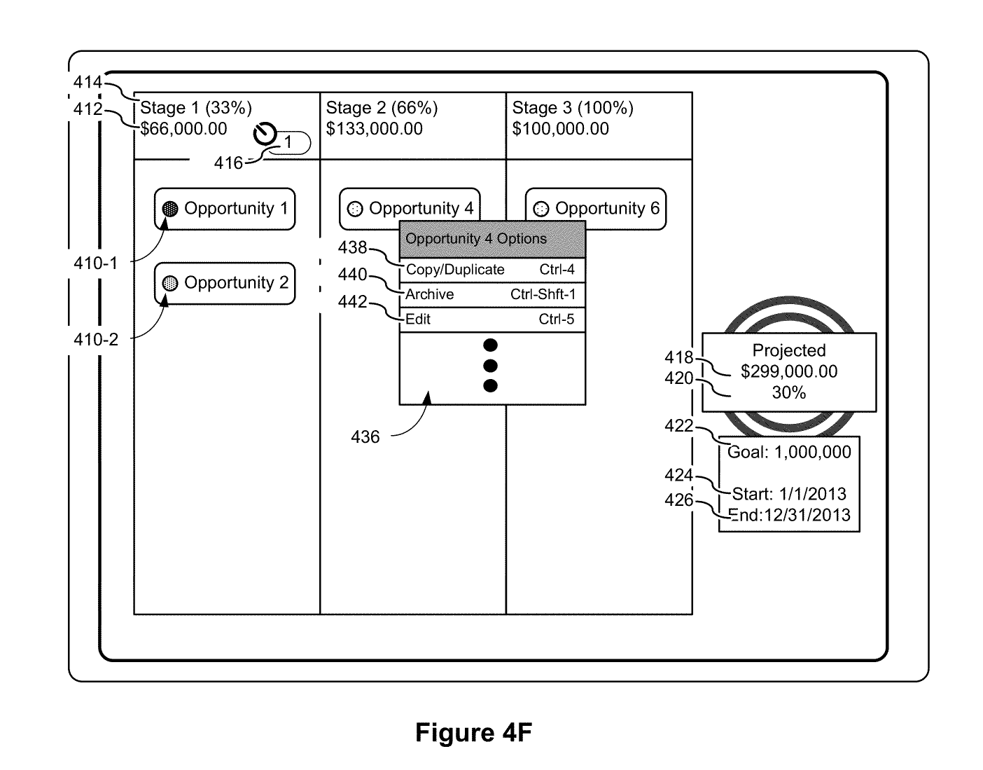

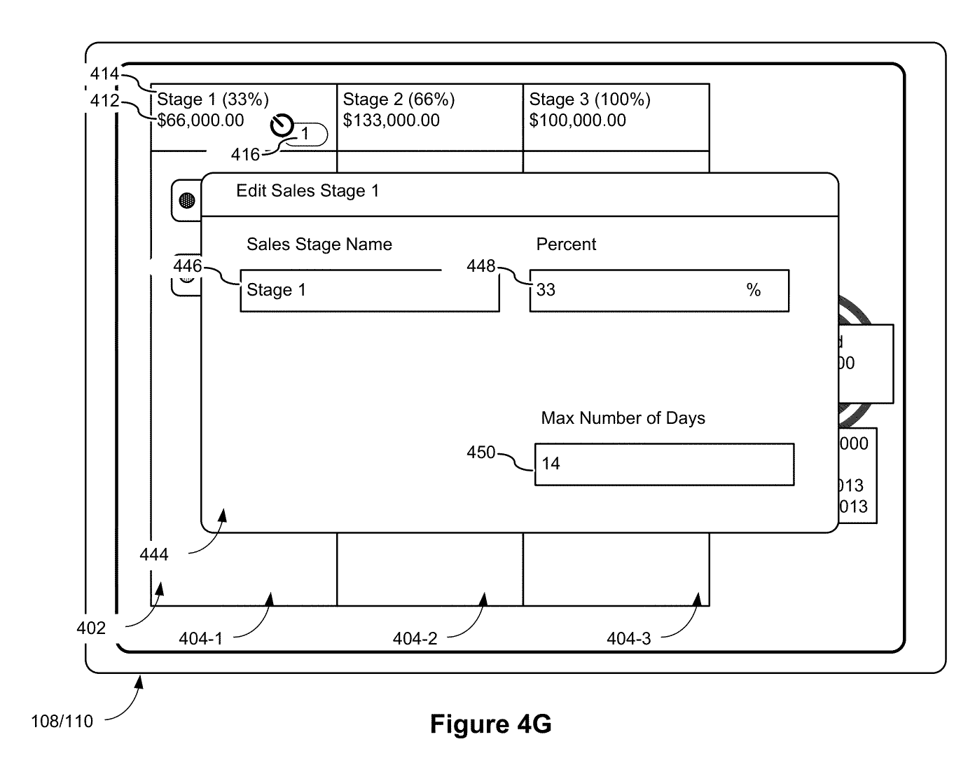

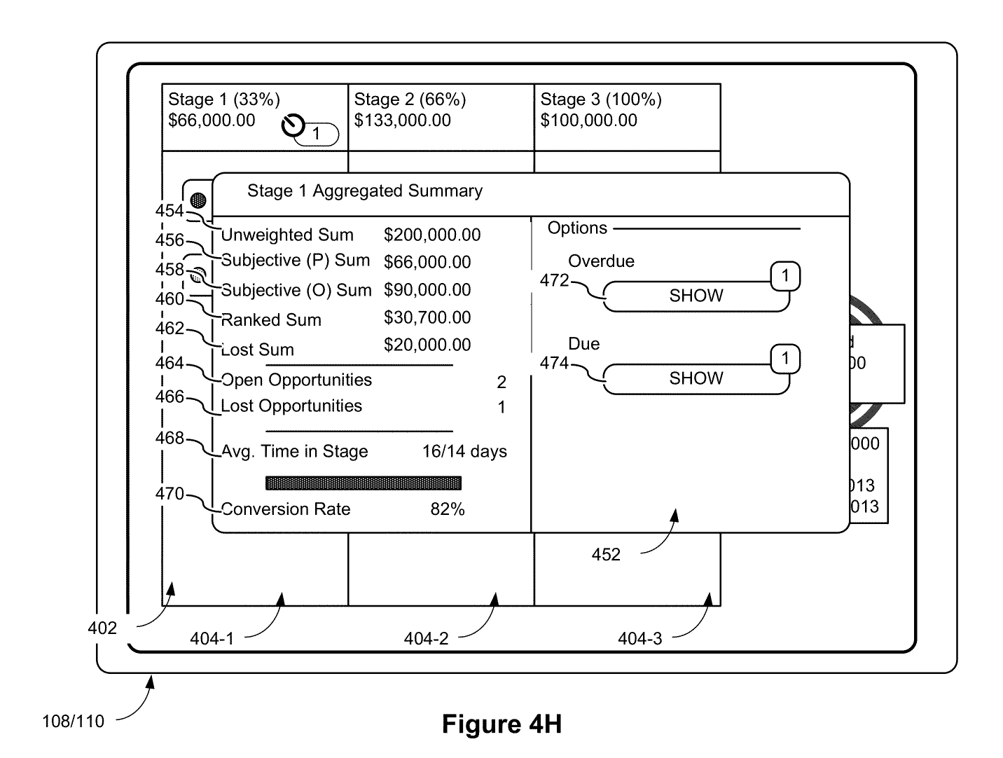

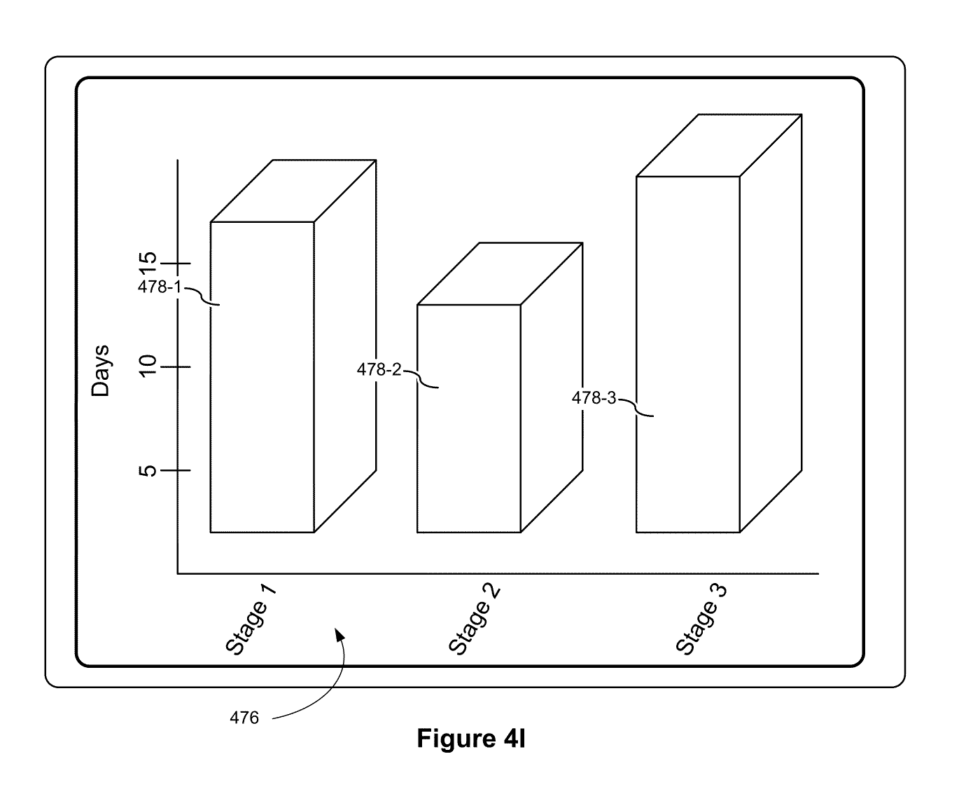

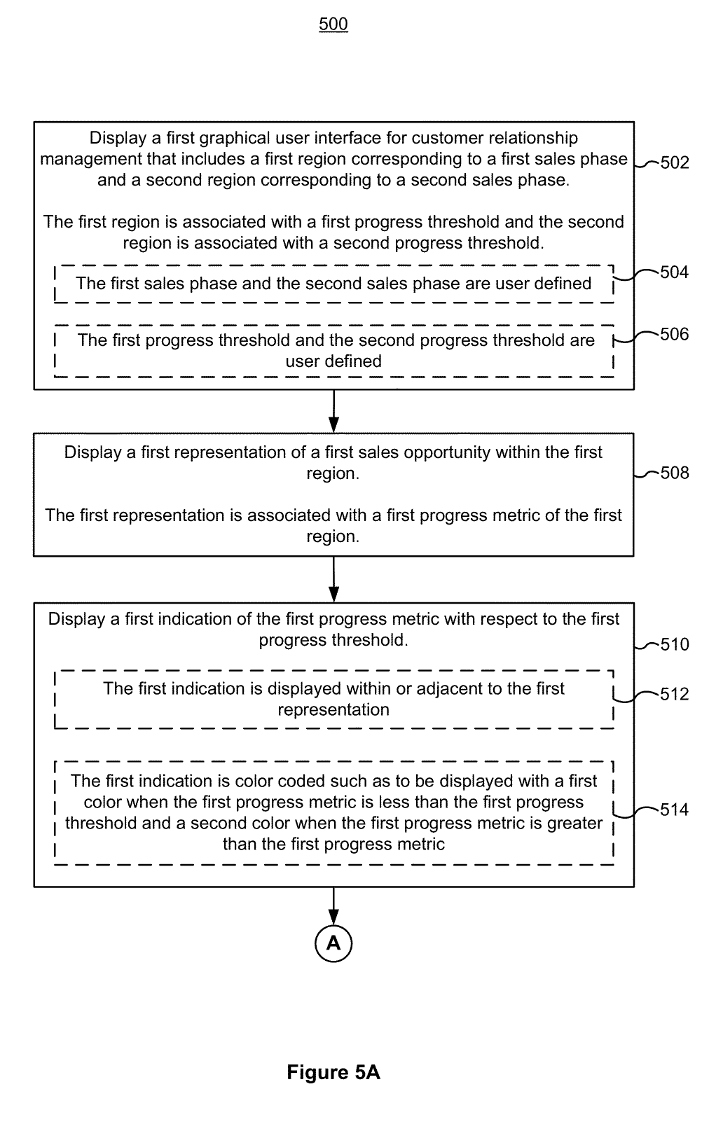

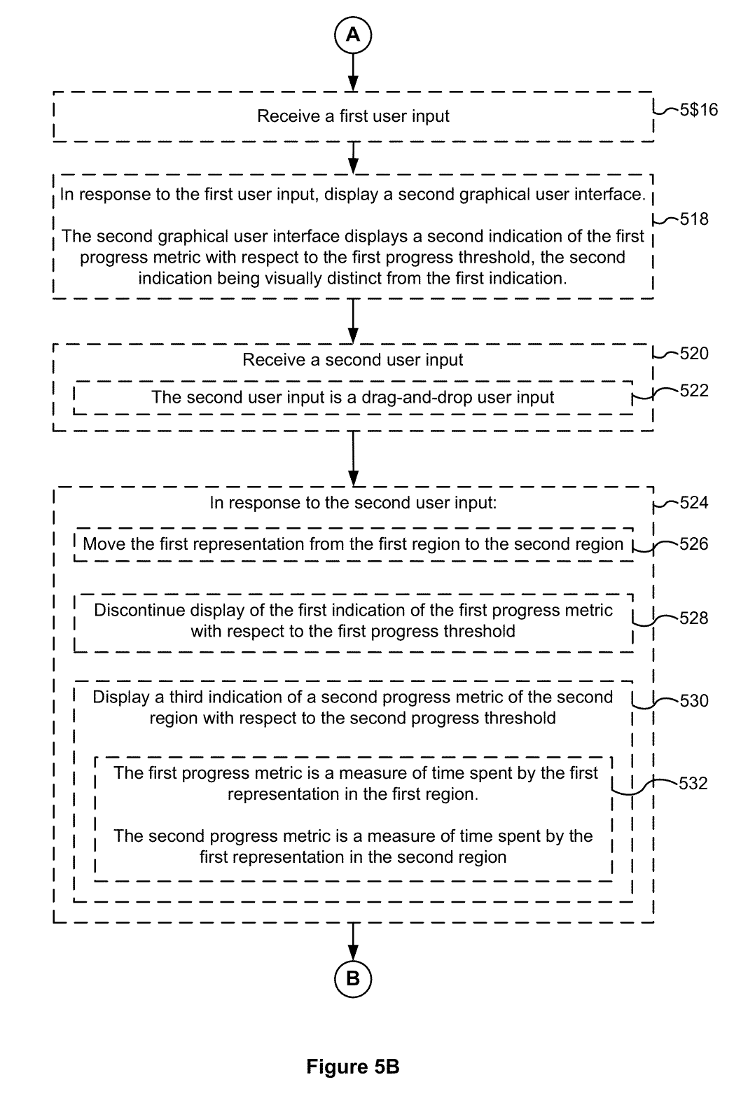

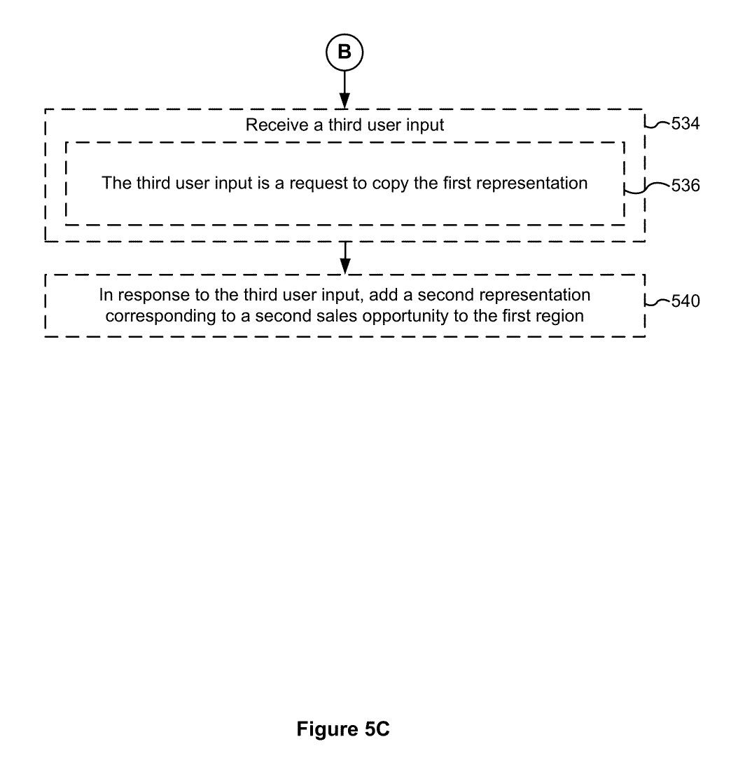

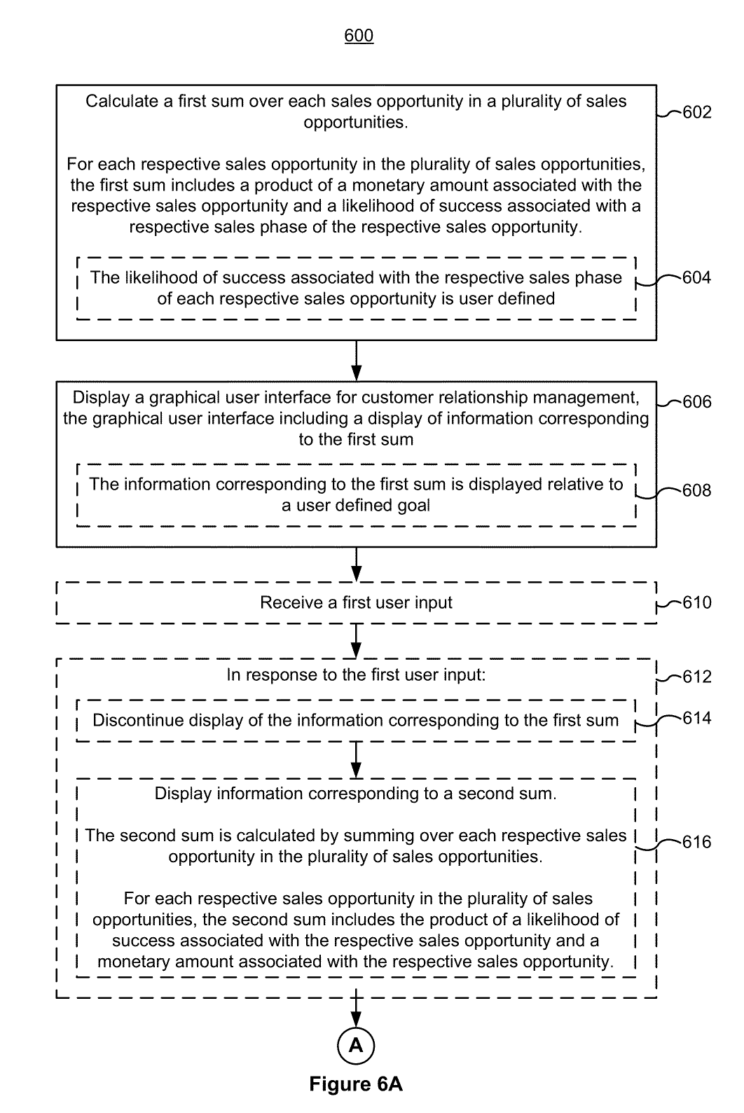

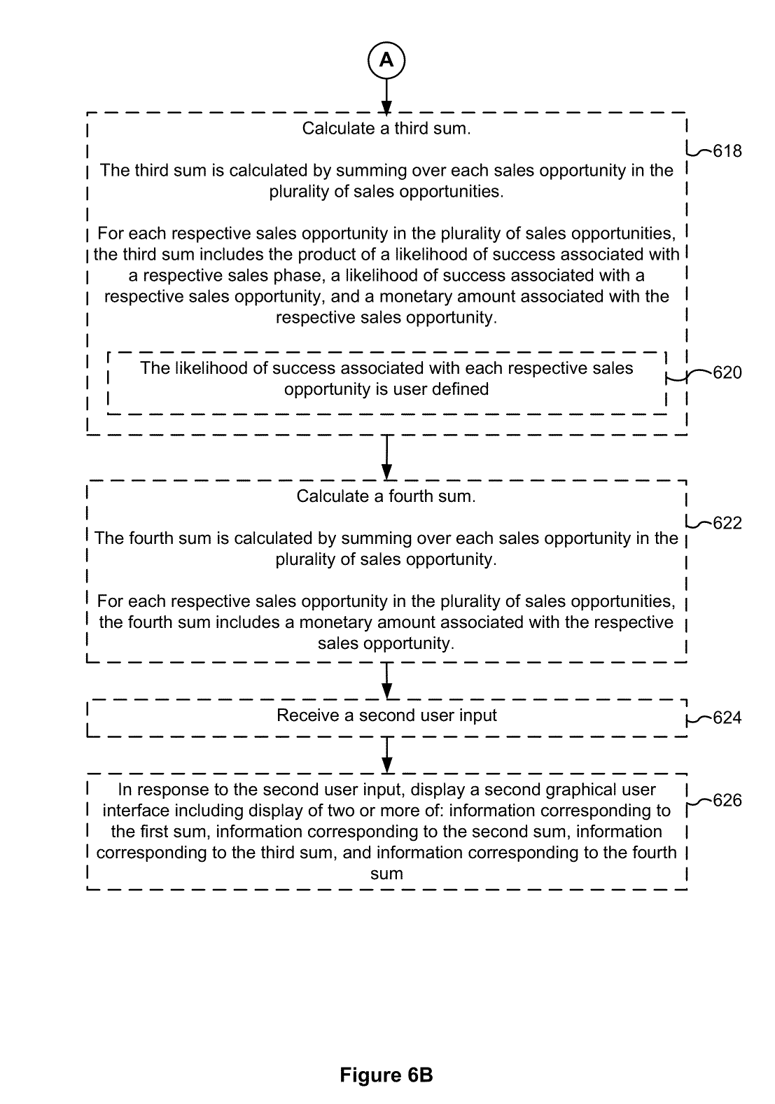

In some implementations, the client-server environment 100 further includes a customer relationship management (CRM) server system 111. Within the CRM server system 111, there is a server computer 112 (e.g., a network server such as a web server) for receiving and processing data received from the client device 108/110. In some implementations, the customer relationship management (CRM) server system 111 stores (e.g., in a database 114) and maintains information corresponding to a plurality of sales opportunities, sales processes, and the like. In some implementations, a company may define one or sales pipelines (e.g., using the user interfaces described with reference to FIGS. 4A-4I and/or according to the methods 500 and 600 described with reference to FIGS. 5A-5C, and FIG. 6A-6B, respectively). For example, a company that frequently does work as a government contractor may establish a pipeline corresponding to the process of winning government contracts (e.g., including an “Initial Bid” phase, a “Stage 1” phase, etc.). The CRM server system 111 would then store information (e.g., appropriate data structures) corresponding to the user-defined pipeline and its associated phases, as well as the sales opportunities within the pipeline. These sales opportunities may include archived sales opportunities, and lost sales opportunities as well as active sales opportunities, so that a user (e.g., a user of a client device 108/110) can, for example, revive an archived sales opportunity when it becomes active again or analyze lost opportunities to understand how and why they were lost. In some implementations, the CRM server system 111 also stores files (e.g., documents) that, for example, have been uploaded to “the cloud” by a user of a client device 108/110. For example, consider a defense contractor vying for a contract to build new jets for the military. In this example, the contract bid will be represented as a sales opportunity within a “Government Contracts” pipeline. A copy of a proposal (including, for example, specifications for the new jets, pricing information, etc.) submitted to the responsible government agency can be associated (e.g., attached) to the sales opportunity. The attached proposal is uploaded to the cloud and stored in database 114.

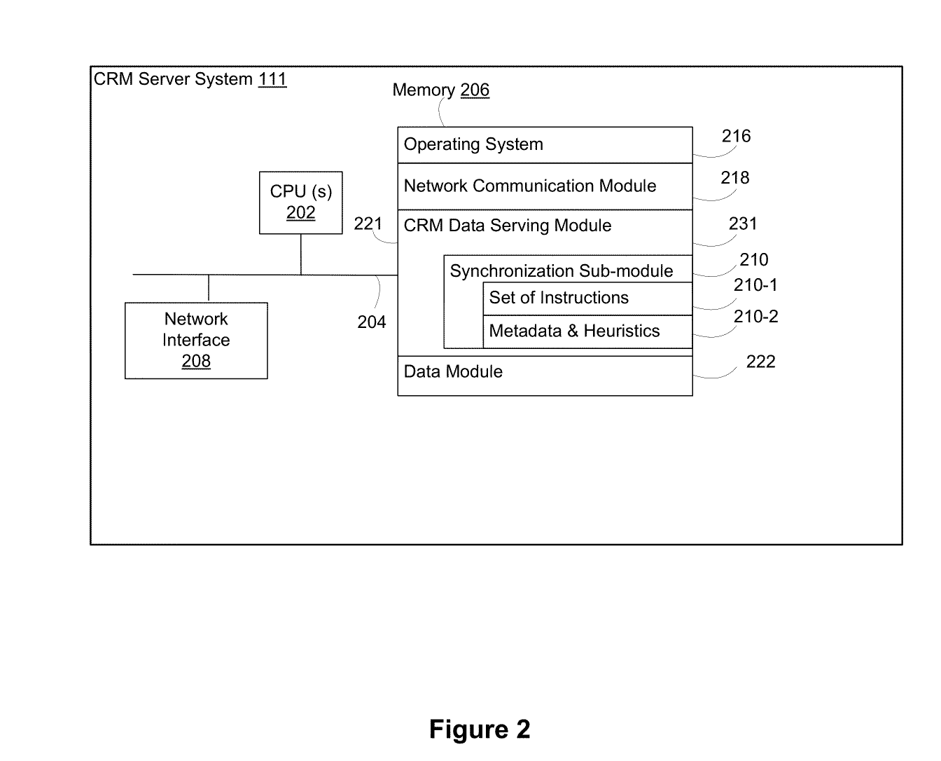

In some implementations, as described in greater detail with reference to FIG. 2, the client device 108/110 and the CRM server system 111 perform a synchronization operation. Thus, the client device 108/110 can generate new or additional data (documents, sales opportunities, etc.) while offline (e.g., unable to communicate with the communications network 106). Once the client device 108/110 is again online (e.g., able to communicate with the communications network 106), the client device 108/110 and the CRM server system 111 exchange data such that, for example, information about a salesperson's sales processes and sales opportunities is uploaded and stored on the cloud. In the same vein, sales processes (e.g., sales pipelines) and sales opportunities generated by other salespeople can be downloaded from the cloud so that a salesperson's client device 108/110 is up-to-date with the latest information from around the company. This synchronization aspect is a boon to salespeople, who can save time and energy by maintaining their focus on sales rather than spending time looking for an Internet connection. The frequent (in some implementations, automatic, e.g., without user intervention) synchronizations serve to back-up salespeople's data and also allow company executives to perform analytics and keep track of their sales.

Those skilled in the art will appreciate from the present disclosure that any number of such devices and/or systems may be provided in a client-server environment, and particular devices may be altogether absent. In other words, the client-server environment 100 is merely an example provided to discuss more pertinent features of the present disclosure. Additional server systems, such as domain name servers and client distribution networks may be present in the client-server environment 100, but have been omitted for ease of explanation.

FIG. 2 is a block diagram illustrating a CRM server system 111, discussed above with reference to FIG. 1, in accordance with some implementations. While certain specific features are illustrated, those skilled in the art will appreciate from the present disclosure that various other features have not been illustrated for the sake of brevity and so as not to obscure more pertinent aspects of the implementations disclosed herein.

To that end, the CRM server system 111 includes one or more processing units (CPU's) 202, one or more network or other communications interfaces 208, memory 206, and one or more communication buses 204 for interconnecting these and various other components. The communication buses 204 may include circuitry (sometimes called a chipset) that interconnects and controls communications between system components. Memory 206 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 206 may optionally include one or more storage devices remotely located from the CPU(s) 202. Memory 206, including the non-volatile and volatile memory device(s) within memory 206, comprises a non-transitory computer readable storage medium.

In some implementations, memory 206 or the non-transitory computer readable storage medium of memory 206 stores the following programs, modules and data structures, or a subset thereof including an operating system 216, a network communication module 218, a CRM data serving module 231, and a data module 222.

The operating system 216 includes procedures for handling various basic system services and for performing hardware dependent tasks.

The network communication module 218 facilitates communication with other devices (e.g., other CRM server systems 111 as well as client devices 108/110) via the one or more communication network interfaces 208 (wired or wireless) and one or more communication networks, such as the Internet, other wide area networks, local area networks, metropolitan area networks, and so on.

The CRM data serving module 231 is configured to manage and distribute information (e.g., contents and metadata) corresponding to various sales pipelines and sales opportunities. To that end, the CRM data serving module 231 optionally includes one or more sub-modules, each including a set of instructions and optionally including metadata. The CRM data serving module 231 also interacts with the data module 222 that stores the data (e.g., sets of pipeline definitions, information about sales opportunities, documents and other files that have been “attached” to sales opportunities, etc.). In some implementations, the CRM data serving module 231 includes a synchronization sub-module 210 that includes a set of instructions 210-a and metadata 210-b. For example, in some implementations, the metadata 210-b includes metadata corresponding to each sales opportunity, uploaded document, set of pipeline definitions, etc. In some implementations, the set of instructions 210-a causes the CRM data serving module 231 to create a shadow record of a set of metadata corresponding to a set of files stored on a respective client device 108/110. When the respective client device 108/110 attempts to synchronize data with the CRM server system 111, the set of instructions 210-a causes the CRM server system 111 to determine a difference between the set of metadata on the client device 108/110 and the shadow record of the set of metadata. For example, the synchronization module 210 compares a document number and a version number for each of the set of files. When one or more documents and/or version numbers differ, the synchronization module 210 initiates a synchronization operation (e.g., an upload/download) of the appropriate files, and updates the shadow record so that it once again matches the synchronized files on the device 108/110.

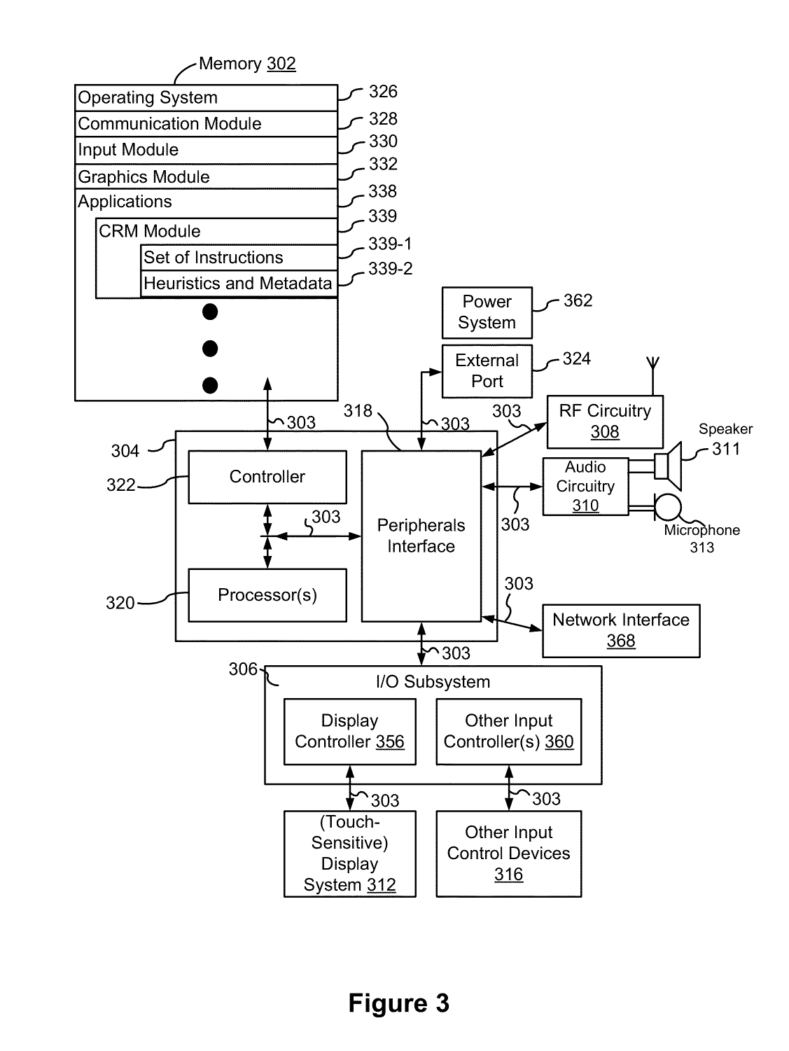

Attention is now directed toward implementations of client devices. FIG. 3 is a block diagram illustrating a client device 108/110, in accordance with some implementations. In some implementations, the client device 108/110 is a smart phone, a laptop computer, a desktop computer, a tablet computer, a multimedia player device, or a smart television. In some implementations, the client device 108/110 includes a display 312 that is a touch-sensitive screen, sometimes called a “touch screen” for convenience. In some implementations, the display 312 is not a touch screen display, and the device 108/110 receives inputs through other input control devices 316, which can include a mouse, keyboard, a joystick, etc. The client device 108/110 includes memory 302 (which optionally includes one or more computer readable storage mediums), a memory controller 322, one or more processing units (CPU's) 320, a peripherals interface 318, RF circuitry 308, audio circuitry 310, a speaker 311, a microphone 313, an input/output (I/O) subsystem 306 and an external port 324. These components optionally communicate over one or more communication buses or signal lines 303.

It should be appreciated that client device 108/110 is only one example of a client device, and that client device 108/110 optionally has more or fewer components than shown, optionally combines two or more components, or optionally has a different configuration or arrangement of the components. The various components shown in FIG. 3 are implemented in hardware, software, or a combination of both hardware and software, including one or more signal processing and/or application specific integrated circuits.

Memory 302 optionally includes high-speed random access memory and optionally also includes non-volatile memory, such as one or more magnetic disk storage devices, flash memory devices, or other non-volatile solid-state memory devices. Access to memory 302 by other components of the client device 108/110, such as the CPU 320 and the peripherals interface 318, is, optionally, controlled by the memory controller 322.

The peripherals interface 318 can be used to couple input and output peripherals of the device to the CPU 320 and memory 302. The one or more processors 320 run or execute various software programs and/or sets of instructions stored in memory 302 to perform various functions for the client device 108/110 and to process data.

In some implementations, the peripherals interface 318, CPU 320, and memory controller 322 are, optionally, implemented on a single chip, such as a chip 304. In some other implementations they are, optionally, implemented on separate chips.

The RF (radio frequency) circuitry 308 receives and sends RF signals, also called electromagnetic signals. The RF circuitry 308 converts electrical signals to/from electromagnetic signals and communicates with communications networks (e.g., the communications network 106, FIG. 1) and other communications devices (e.g., the station 103, FIG. 1) via the electromagnetic signals. The RF circuitry 308 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 308 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-cell HSPA (DC-HSPDA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for e mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

The audio circuitry 310, speaker 311, and microphone 313 provide an audio interface between a user and the client device 108/110. The audio circuitry 310 receives audio data from the peripherals interface 318, converts the audio data to an electrical signal, and transmits the electrical signal to the speaker 311. The speaker 311 converts the electrical signal to human-audible sound waves. The audio circuitry 310 also receives electrical signals converted by the microphone 313 from sound waves. The audio circuitry 310 converts the electrical signal to audio data and transmits the audio data to the peripherals interface 318 for processing. Audio data is, optionally, retrieved from and/or transmitted to memory 302 and/or the RF circuitry 308 by the peripherals interface 318. In some implementations, the audio circuitry 310 also includes a headset jack. The headset jack provides an interface between the audio circuitry 310 and removable audio input/output peripherals, such as output-only headphones or a headset with both output (e.g., a headphone for one or both ears) and input (e.g., a microphone).

The I/O subsystem 306 couples input/output peripherals on the client device 108/110, such as a touch screen 312 and the other input control devices 316, to the peripherals interface 318. The I/O subsystem 306 optionally includes a display controller 356, and one or more input controllers 360 for other input or control devices. The one or more input controllers 360 receive/send electrical signals from/to other input or the control devices 316. The other input control devices 316 optionally include physical buttons (e.g., push buttons, rocker buttons, etc.), dials, slider switches, joysticks, click wheels, and so forth. In some alternate implementations, the input controller(s) 360 are, optionally, coupled to any (or none) of the following: a keyboard, infrared port, USB port, and a pointer device such as a mouse. The one or more buttons optionally include an up/down button for volume control of the speaker 311 and/or the microphone 313. The one or more buttons optionally include a push button.

In some implementations, the display 312 is a touch screen display 312. The touch screen 312 provides an input interface and an output interface between the device and a user. The display controller 356 receives and/or sends electrical signals from/to the touch screen 312. The touch screen 312 displays visual output to the user. The visual output optionally includes graphics, text, icons, video, and any combination thereof (collectively termed “graphics”). In some implementations, some or all of the visual output corresponds to user-interface objects.

The touch screen 312 has a touch-sensitive surface, sensor or set of sensors that accepts input from the user based on haptic and/or tactile contact. The touch screen 312 and the display controller 356 (along with any associated modules and/or sets of instructions in memory 302) detect contact (and any movement or breaking of the contact) on the touch screen 312 and converts the detected contact into interaction with user-interface objects (e.g., one or more soft keys, icons, web pages or images) that are displayed on the touch screen 312. In an exemplary implementation, a point of contact between the touch screen 312 and the user corresponds to a finger of the user.

The touch screen 312 optionally uses LCD (liquid crystal display) technology, LPD (light emitting polymer display) technology, or LED (light emitting diode) technology, although other display technologies are used in other implementations. The touch screen 312 and the display controller 356 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the touch screen 312.

In some implementations, in addition to the touch screen, the client device 108/110 optionally includes a touchpad (not shown) for activating or deactivating particular functions. In some implementations, the touchpad is a touch-sensitive area of the device 108/110 that, unlike the touch screen, does not display visual output. The touchpad is, optionally, a touch-sensitive surface that is separate from the display 312.

The client device 108/110 also includes a power system 362 for powering the various components. The power system 362 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in devices.

In some implementations, the software components stored in memory 302 include an operating system 326, communication module (e.g., set of instructions and/or metadata) 328, a graphics module (e.g., set of instructions and/or metadata) 332, and one or more applications (e.g., set of instructions and/or metadata) 338.

The operating system 326 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 328 facilitates communication with other devices over one or more external ports 324 and also includes various software components for handling data received by the RF circuitry 308 and/or the external port 324. The external port 324 (e.g., Universal Serial Bus (USB), FIREWIRE, etc.) is adapted for coupling directly to other devices or indirectly over a network (e.g., the Internet, wireless LAN, etc.).

The graphics module 332 includes various known software components for rendering and displaying graphics on the touch screen 312 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some implementations, the graphics module 332 stores data representing graphics to be used. Each graphic is, optionally, assigned a corresponding code. The graphics module 332 receives, from applications etc., one or more codes specifying graphics to be displayed along with, if necessary, coordinate data and other graphic property data, and then generates screen image data to output to the display controller 356.

The one or more applications 338 optionally include a CRM module 339. In some implementations, the CRM module 339 includes a first set of instructions that causes the device 108/110 to display a first graphical user interface (e.g., graphical user interface 402, FIG. 4A) for customer relationship management that includes a first region corresponding to a first sales phase (e.g., region 404-1, FIG. 4A) and a second region corresponding to a second sales phase (e.g., region 404-2, FIG. 4A). The first sales phase is associated with a first progress threshold and the second sales phase is associated with a second progress threshold. The first set of instructions further causes the device 108/110 to display a first representation of a first sales opportunity within the first region (e.g., representation 408-1, FIG. 4A). The first representation is associated with a first progress metric of the first sales phase. The first set of instructions further causes the device 108/110 to display a first indication of the first progress metric with respect to the first progress threshold (e.g., indication 410-1, FIG. 4A).

In some implementations, the CRM module 339 includes a second set of instructions that causes the device 108/110 to calculate a first sum over each sales opportunity in a plurality of sales opportunities (e.g., each of the sales opportunities in region 404-1, FIG. 4A or each sales opportunity managed by a particular salesperson). For each respective sales opportunity in the plurality of sales opportunities, the first sum includes a product of a monetary amount associated with the respective sales opportunity and a likelihood of success associated with a respective sales phase of the respective sales opportunity. The second set of instructions further causes the device 108/110 to display a graphical user interface for customer relationship management, the graphical user interface including a display of information corresponding to the first sum.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various implementations. In some implementations, memory 302 optionally stores a subset of the modules and data structures identified above. Furthermore, memory 302 optionally stores additional modules and data structures not described above.

FIGS. 4A-4I illustrate user interfaces for customer relation management, in accordance with some implementations. The user interfaces in these figures are used to illustrate the processes described below, including the processes in FIGS. 5A-5C and FIGS. 6A-6B. For convenience of explanation, these user interfaces are illustrated with reference to a client device 108/110 with a touch screen display 312. In particular, these figures illustrate a sequence in which a user manipulates a sales opportunity by moving it from a first region corresponding to a first sales phase to a second region corresponding to a second sales phase. In doing so, various analytics are calculated and displayed, as described below.

As shown in FIG. 4A, in some implementations, the device 108/110 displays a first graphical user interface 402 for customer relationship management. The first graphical user interface 402 includes a plurality of regions 404 (e.g., a first region 404-1, a second region 404-2, and a third region 404-3). In some implementations, each of the regions corresponds to a sales phase that can be defined by the user. For example, the first region 404-1 is associated with a “Stage 1” sales phase. Moreover, in some implementations, one or more sales phases are associated with a progress threshold. In some embodiments, each progress threshold is a user-defined number of days (e.g., the user is prompted to enter a maximum number of days that respective sales opportunities should stay in the phase before advancing to the next phase). The progress threshold for the phase is stored in the device 108/110 in a lookup table or another appropriate data structure. For example, a company (or a salesperson) may know that sales opportunities that do not advance past the “Stage 1” sales phase within two weeks (i.e., 14 days) tend to become “stale,” meaning that they become increasingly unlikely to mature into actual sales.

In some implementations, the device 108/110 displays one or more representations 408 of sales opportunities within the regions 404 (e.g., the representations 408-1, 408-2, and 408-3 are in region 404-1, the representation 408-4 is in region 404-2, and the representation 408-5 is in region 404-3). One or more of the representation is associated with a respective progress metric, which the device 108/110 tracks and stores. In some implementations, a progress metric is a measure of time spent by a respective representation in a respective region (e.g., a number of days the sales opportunity has already spent in a “Stage 1” of the sales pipeline). As an example, in some implementations, when the representation 408-3 has spent nine days in “Stage 1” of the sales pipeline, the progress metric for the corresponding sales opportunity in “Stage 1” will be nine days.

In some implementations, the device 108/110 displays, for each representation 408, an indication 410 of the progress metric with respect to the progress threshold (e.g., indication 410-1 corresponding to representation 408-1, indication 410-2 corresponding to representation 408-2, and indication 410-3 corresponding to representation 408-3). For example, the respective indication 410-1 is shown in a darker fill pattern than indication 410-2 because the progress metric for representation 408-1 is greater than (or, in some implementations, equal to) the corresponding progress threshold for “Stage 1,” while the progress metric for representation 408-2 is less than the corresponding progress threshold for “Stage 1.”

In some implementations, the respective indication 410 is within or adjacent to the corresponding representation 408 (e.g., as shown in FIG. 4A, the respective indications 410 are shown within the corresponding representations 408). In some implementations, the indications 410 are color coded such as to be displayed with a first color (e.g., green) when the corresponding progress metric is less than the corresponding progress threshold and a second color (e.g., red) when the corresponding progress metric is greater than the corresponding progress threshold. In some embodiments, the indications 410 are color coded according to more than two colors. For example, the user may set an alert for three days ahead of the progress threshold for the “Stage 1” sales phase. Representations with progress metrics less than the alert time are then displayed in a first color (e.g., green), representations with progress metrics greater than the alert time but less than the progress threshold are displayed in a second color (e.g., yellow), and representations with progress metrics greater than the progress threshold are displayed in a third color (e.g., red). For example, representation 410-2 is depicted as having a shading color between that of representations 410-1 and 410-4. Such implementations are not intended to be limiting, however, and in some implementations, any number of colors and/or a color scale may be used to represent the urgency of advancing the sales opportunity.

In some implementations, the device 108/110 displays in the first graphical user interface 402 information about the sales opportunities within each of the regions (stages, phases) 404. For example, as shown in FIG. 4A, the graphical user interface 402 includes information 412 indicating the total monetary value of the sales opportunities in that phase of the pipeline (e.g., “Stage 1” sales opportunities are collectively valued at $100,000). As described in greater detail below, the valuation of the total monetary value of sales opportunities in that phase can be done in a number of ways, including, optionally: an unweighted sum, a subjective phase-based sum, a subjective opportunity-based sum, or a rank sum.

The graphical user interface also includes information 414 indicating the name of the sales phase (e.g., “Stage 1”) and a likelihood of success (weighting) associated with the sales phase (e.g., 33%). The likelihood of success associated with the sales phase can be defined by the user based on direct knowledge of the likelihood that a “Stage 1” opportunity will mature into an actual sale (or by company executives). Alternatively, the likelihood of success associated with sales phase can be determined automatically by the device 108/110 based on historical data.

In some implementations, the graphical user interface 402 also displays information 416 indicating the number of sales opportunities within the respective region that are stale (e.g., with progress metrics greater than the progress threshold for the respective sales phase).

In some embodiments, one or more of the information 412, 414, and 416 are displayed within a respective display region that corresponds to a user-selectable affordance. For example, in some implementations, a user can select, via a user input, information 416 to view a list of the stale opportunities. As another example, in some implementations, the user can select information 414 to edit phase details, as shown and described with reference to FIG. 4F.

In some implementations, the device 108/110 also displays information 418 corresponding to a total monetary value of sales opportunities within the sales pipeline. In some implementations, the device 108/110 displays information 420 corresponding to the total monetary value relative to a goal 422. The goal 422 can optionally be defined using a start date 424 and an end date 426, which are modifiable by the user. In some implementations, the valuation of the total monetary value of sales opportunities in sales pipeline can be done in a number of ways, including, optionally: an unweighted sum, a subjective phase-based sum, a subjective opportunity-based sum, or a rank sum.

FIG. 4B is analogous to FIG. 4A, except that in FIG. 4B the device 108/110 detects a first user input 428 (e.g., receives a first user input). As used herein, the term “user input” may be construed to mean one or more commands detected from an input device such as a touchpad, touch screen display, mouse, keyboard, joystick, or the like. To be a user input, it is sufficient that the device 108/110 recognize the user's actions as an event. For example, in some implementations, the first user input 428 is a “hover” input over representation 408-3 (e.g., a user input in which a focus selector, such as a cursor, remains over representation 408-3 for a predefined amount of time). In some implementations, the first user input 428 is a contact, or a swipe on a touch-sensitive surface (e.g., a touchpad or a touch screen display). In some implementations, the first user input 428 is a mouse-click. In some implementations, the first user input 428 is a right-click on a mouse followed by display of a drop-down menu and selection of an appropriate affordance within the drop-down menu.

In any event, as shown in FIG. 4C, in response to the first user input 428, the device 108/110 displays a second graphical user interface 430. The second graphical user interface 430 displays a second indication 432 of the first progress metric with respect to the first progress threshold. The second indication 432 is visually distinct from the first indication 410-3. For example, as shown in FIG. 4C, the second indication 432 is a bar graph. In some implementations, the second user interface 430 provides the user with a greater degree of granularity and detail with regards to the first progress metric. For example, the second user interface 430 indicates that the representation 408-3 has been in the first region for nine days compared to the first progress threshold of fourteen days. In some implementations, the second indication 432 is another form of graph or visual representation, such as an incomplete pie graph, a clock, a stopwatch, an hour glass, etc.

Returning to the first graphical user interface 402, FIG. 4D illustrates the device 108/110 receiving a second user input 434, which is illustrated as a drag-and-drop input for representation 408-3 starting at a location indicated by 434-a.

As shown in FIG. 4E, the second user input 434 terminates at a location within the second region indicated by 434-b. In response to the second user input 434, the device 108/110 moves the representation 408-3 from the region 404-1 to the region 404-2. The device 108/110 discontinues display of the indication 410-3 of the first progress metric with respect to the first progress threshold, and instead displays a new indication 410-4 of a second progress metric of the second sales phase (e.g., a “Stage 2” sales phase) with respect to the second progress threshold. For example, the user (or company executives) may have set the progress threshold to twenty-one days for the second region. Upon moving to the second region, the sales opportunity has a second progress metric of zero days relative to the threshold of twenty-one. Thus, the indication 410-1 is illustrated in the lightest fill (among the three fill shades illustrated in FIG. 4E). In the case that the progress metric is inaccurate (e.g., because the salesperson has not had time to update the sales pipeline for a few days), the progress metrics may be updated manually. In addition, information 418 updates because representation 408-3 corresponds to a sales opportunity that is now more likely to mature into an actual sale. Information 420 increases for an analogous reason, while information 412 decreases because there is now less value in “Stage 1” of the pipeline (by virtue of a sales opportunity advancing out of the phase). When an opportunity 408 is moved by the user from a source stage 414 to a target stage 414 using the device 108/110, for instance in the manner illustrated in FIG. 3, the opportunity 408 is associated with the target stage 414 both within the GUI and the database on the CRM server system 111. Advantageously, there is no requirement that the device 108/110 be connected to the database 114 via communication network when the opportunity was moved by the user from a source stage 414 to a target stage 414. The relevant data structures in the database 114 that track associations between opportunities 408 and stage 414 can be updated at a later time when the device 108/110 is synchronized with the CRM server system 111 via a communication network 106.

As shown in FIG. 4F, in some implementations, the device 108/110 displays a drop-down menu 436. In some implementations, the drop-down 436 optionally includes an affordance 438 for copying a sales opportunity, an affordance 440 to archive a sales opportunity, and an affordance 442 to edit the details of a sales opportunity. In some implementations, drop-down menu 436 is invoked by right-clicking with a mouse over a respective representation of a sales opportunity. In some implementations, drop-down menu 436 is invoked by a predetermined keystroke combination.

As shown in FIG. 4G, in some implementations, the device 108/110 displays a third graphical user interface 444 for editing the user-defined details of a respective sales phase. The third graphical user interface 444 includes a field 446 for editing the name of the sales phase, a field 448 for editing a user-defined likelihood of success associated with the sales phase, and a field 450 for editing the progress threshold of the sales phase. Although fields 446, 448, and 450 are shown as text-fields, other well-known graphical user interface features may be substituted for the text fields. For example, a drag-bar or slider may be substituted for field 450. In such an example, the user would enter a value by moving the drag-bar or slider until the corresponding displayed value is what the user wants. In some implementations, a similar user interface is used when creating a new phase (e.g., adding a new phase to the sales pipeline).

As shown in FIG. 4H, in some implementations, the device 108/110 displays a fourth graphical user interface 452, for displaying aggregated summary information about sales opportunities within a respective sales phase. For example, the fourth graphical user interface 452 includes information 454 indicating an unweighted sum corresponding to the sales opportunities within the phase, information 456 indicating a subjective phase-based sum corresponding to the sales opportunities within the phase, information 458 indicating a subjective opportunity-based sum corresponding to the sales opportunities within the phase, information 460 indicating a rank sum corresponding to the sales opportunities within the phase, and information 462 indicating a lost sum corresponding to the sales opportunities that failed to advance beyond the respective phase. The details of various implementations for how to calculate these sums are described in greater detail with reference to FIGS. 6A and 6B as well as the method 600 below.

The fourth graphical user interface 452 also optionally includes information 464 corresponding to a count of current sales opportunities within the phase and information 466 corresponding to a count of lost sales opportunities that failed to advance beyond the phase. The fourth graphical user interface 452 also optionally includes information 468 corresponding to an average number of days spent by sales opportunities within the phase (e.g., 16 days with a progress threshold of 14 days), information 470 corresponding to a conversation rate (e.g., a percentage of sales opportunities that advance from “Stage 1” to stage 2). In some implementations, information 468 and 470 automatically update when a sales opportunity is advanced out of the phase. The fourth graphical user interface 452 also optionally includes an affordance 472 (e.g., a button) that offers the user more information about overdue sales opportunities (e.g., stales opportunities with a progress metric greater than the progress threshold for the sales phase) and an affordance 474 that offers the user more information about due sales opportunities (e.g., sales opportunity with a progress metric within an alert time of the progress threshold).

As shown in FIG. 4I, in some implementations, the device 108/110 displays a dashboard 476 summarizing information about a plurality of sales opportunities. For example, dashboard 476 includes a bar graph with bars 478 indicating the average amount of time sales opportunities spend in each respective phase (e.g., the bar 478-1 indicates that sales opportunities spend an average of sixteen days in “Stage 1,” the bar 478-2 indicates that sales opportunities spend an average of twelve days in Stage 2, and the bar 478-3 indicates that sales opportunities spend an average of eighteen days in Stage 3).

FIGS. 5A-5C are flow diagrams illustrating a method 500 of manipulating representations of sales opportunities within a customer relationship management environment, in accordance with some implementations. In some implementations, the method 500 is performed at an electronic device (e.g., the client device 108/110) with a display. In some implementations, the display is a touch screen display (e.g., the touch screen 312, FIG. 3) and includes a touch-sensitive surface is on the display. In some implementations, the display is separate from an input device used by the user to manipulate sales opportunities (e.g., drag-and-drop sales opportunities from one phase to another).

Some operations in the method 500 are, optionally, combined and/or the order of some operations is, optionally, changed.

As described below, the method 500 provides the salesperson with the decision-making freedom needed to achieve the best results under the best conditions, opening the way to planning and control. To that end, a salesperson can plan their opportunities based on their work process (e.g., by defining sales phases of a sales pipeline) and also shape their risk accordingly (e.g., by easily viewing which sales opportunities are growing “stale”). This ability increases motivation and sales success.

According to the method 500, the device displays (502) a first graphical user interface for customer relationship management that includes a first region corresponding to a first sales phase and a second region corresponding to a second sales phase. For example, the graphical user interface 402 (FIG. 4A) includes a first region 404-1 corresponding to a “Stage 1” sales phase and a second region 404-2 corresponding to a “Stage 2” sales phase. The first sales phase is associated with a first progress threshold and the second sales phase is associated with a second progress threshold.

In some implementations, the first sales phase and the second sales phase are (504) user-defined (e.g., the user can create a new phase and edit the details with the user interface 444, FIG. 4G). In some implementations, the first progress threshold and the second progress threshold are (506) user-defined (e.g., with the user interface 444, FIG. 4G).

The device displays (508) a first representation of a first sales opportunity within the first region (e.g., representations 408, FIG. 4A). The first representation is associated with a first progress metric of the first sales phase.

The device displays (510) a first indication of the first progress metric with respect to the first progress threshold (e.g., indications 410, FIG. 4A). In some implementations, the first indication is displayed (512) within or adjacent to the first representation. In some implementations, the first indication is (514) color coded such as to be displayed with a first color when the first progress metric is less than the first progress threshold and a second color when the first progress metric is greater than the first progress threshold.

In some implementations, one or more parameters, such as the first and second progress thresholds, are stored in a look-up table. The look-up table is optionally stored on a server system (e.g., server 111, FIG. 1) and synchronized with the device. The server/device also store permissions for different users limiting their ability to modify parameters (e.g., progress thresholds). A company executive or system administrator may have full permission to modify the first progress threshold from twenty-one days to eighteen-days. On the other hand, a salesperson may only have permission to access the first progress threshold in order to display the first indication accurately.

In some implementations, the device stores objects corresponding to the sales phases and the sales opportunities. For example, when a user with permission defines a new sales phase, the device instantiates a new sales phase object having instance variables for a sales phase name, a progress threshold, a likelihood of success for the sales phase, etc. Similarly, when a user defines a new sales opportunity, the device instantiates a new sales opportunity object having instance variables for a sales opportunity name, monetary amount of the sales opportunity, a progress metric of the sales opportunity, a pointer to a current sales phase of the sales opportunity, etc.

In some implementations, the device receives (516) a first user input (e.g., the user input 428, FIG. 4B). In response to the first user input, the device displays (518) a second graphical user interface (e.g., the graphical user interface 430, FIG. 4C). The second graphical user interface displays a second indication of the first progress metric with respect to the first progress threshold, the second indication being visually distinct from the first indication. For example, the graphical user interface 430 in FIG. 4C displays the indication 432.

In some implementations, the device receives (520) a second user input (e.g., user input 434, FIGS. 4D-4E). In some implementations, the second user input is (522) a drag-and-drop user input. In response to the second user input (524), the device moves (526) the first representation from the first region to the second region (e.g., as shown in FIG. 4E), discontinues (528) display of the first indication of the first progress metric with respect to the first progress threshold, and displays (530) a third indication of a second progress metric of the second sales phase with respect to the second progress threshold (e.g., indication 410-5 is a “reset” version of indication 410-3, FIGS. 4D-4E). In some implementations, the first progress metric is (532) a measure of time spent by the first representation in the first region, and the second progress metric is a measure of time spent by the first representation in the second region. In some implementations, an instance variable for the progress metric automatically updates based on a date and time (e.g., the progress metric increments by a value of one each day).

In some implementation, the user's actions cause the device to update parameters stored in a look-up table and/or a user-defined object. For example, when a user drags-and-drops a sales opportunity from the first region to the second region, the device automatically updates the sales opportunity to point to the second sales phase (e.g., by updating the pointer to the sales phase), and resets the progress metric to a predefined value (e.g., zero).

In some implementations, the device receives (534) a third user input. In some implementations, the third user input is (536) a request to copy the first representation (e.g., using the copy option 438 in drop-down menu 436, FIG. 4F). In response to the third user input, the device adds (540) a second representation corresponding to a second sales opportunity to the first region.

FIGS. 6A-6B are flow diagrams illustrating a method 600 of projecting a value associated with a plurality of sales opportunities within a phased customer relationship management environment, in accordance with some implementations. In some implementations, the method 600 is performed at an electronic device (e.g., the client device 108/110) with a display. In some implementations, the display is a touch screen display (e.g., the touch screen 312, FIG. 3) and the touch-sensitive surface is on the display. In some implementations, the display is separate from an input device used by the user to manipulate sales opportunities (e.g., drag-and-drop sales opportunities from one phase to another).

In some implementations, a server system (e.g., the CRM server system 111, FIG. 1) performs some or all of the operations of the method 600. Some operations in the method 600 are, optionally, combined and/or the order of some operations is, optionally, changed.

As a sales opportunity advances in a sales pipeline, the likelihood that the sales opportunity will mature into an actual sale increases, and therefore the value of that sales opportunity increases. It is important to be able to calculate the value of such a sales opportunity to the company by weighting a nominal value of the sales opportunity by a likelihood of success. However, the likelihood of success can be in a number of ways. For example, the likelihood of success can be defined for a particular sales opportunity (e.g., defined by the salesperson, who has the best intuition for how the opportunity is progressing). This is sometimes referred to as a “subjective opportunity-based” valuation. Alternatively, the likelihood of success can be defined for a sales phase to which the sales opportunity belongs (e.g., based on historical data). This is sometimes referred to as a “subjective phase-based” valuation.

Consider, as an example, a defense contractor vying for a contract to build new jets for the military. The contract may be in the “Initial Bid” phase, and the company may know that historically 33% of the company's initial bids will result in an actual contract. Therefore, the value of the sales opportunity (the potential value of the contract if it matures into an actual sale) could be weighted by 0.33. This is an example of a likelihood of success associated with a respective sales phase of the respective sales opportunity. Alternatively, a salesperson responsible for managing the contract bid may know, from their expertise and experience, that the initial bid is particularly strong, or that their competition is unusually weak, or that the bid was well-received by the reviewers. The salesperson may feel that the sales opportunity has a 40% chance of maturing into an actual contract, and therefore the value of the sales opportunity could be weighted by 0.40. This is an example of a likelihood of success associated with a sales opportunity. As described below, the method 600 provides an intuitive and engaging way to value a plurality of sales opportunities and project progress towards a yearly monetary goal.

According to the method 600, the device calculates (602) a first sum over each sales opportunity in a plurality of sales opportunities (a so-called “subjective phase-based” value). For each respective sales opportunity in the plurality of sales opportunities, the first sum includes a product of a monetary amount associated with the respective sales opportunity and a likelihood of success associated with a respective sales phase of the respective sales opportunity. In some implementations, the likelihood of success associated with the respective sales phase of each respective sales is (604) user-defined. For example, the first sum may be calculated using the equation:

A=Σᵢ^{N}Aᵢ×P(φᵢ), (1)

where A is the valuation over the plurality of sales opportunities (e.g., all of the opportunities within a given phase in the pipeline, or all of the opportunities being managed by a particular salesperson, etc.), Aᵢ is the nominal value of the i^{th} sales opportunity (e.g., the value to the company if the sales opportunity matures into an actual sale), P(φᵢ) is the probability of success associated with the respective sales phase of the i^{th} sales opportunity, and N is the number of sales opportunities in the plurality of sales opportunities.

The device displays (606) a graphical user interface for customer relationship management, the graphical user interface including a display of information corresponding to the first sum. In some implementations, the information corresponding to the first sum is (608) displayed relative to a user-defined goal.

In some implementations, the device receives (610) a first user input. In response to the first user input (612), the device discontinues (614) display of the information corresponding to the first sum, and displays (616) information corresponding to a second sum (a so-called “subjective opportunity-based sum”). The second sum is calculated by summing over each respective sales opportunity in the plurality of sales opportunities. For each respective sales opportunity in the plurality of sales opportunities, the second sum includes the product of a likelihood of success associated with the respective sales opportunity and a monetary amount associated with the respective sales opportunity. For example, the second sum may be calculated using the equation:

A=Σᵢ^{N}Aᵢ×Pᵢ, (2)

where A is the valuation over the plurality of sales opportunities (e.g., all of the opportunities within a given phase in the pipeline, or all of the opportunities being managed by a particular salesperson, etc.), Aᵢ is the nominal value of the i^{th} sales opportunity (e.g., the value to the company if the sales opportunity matures into an actual sale), Pᵢ is the probability of success associated with the i^{th} sales opportunity, and N is the number of sales opportunities in the plurality of sales opportunities.

In some implementations, the device calculates (618) a third sum (a so-called “rank sum”). The third sum is calculated by summing over each sales opportunity in the plurality of sales opportunities. For each respective sales opportunity in the plurality of sales opportunities, the third sum includes the product of a likelihood of success associated with a respective sales phase, a likelihood of success associated with a respective sales opportunity, and a monetary amount associated with the respective sales opportunity. For example, the third sum may be calculated using the equation:

A=Σᵢ^{N}Aᵢ×P(φᵢ)×Pᵢ, (1)

where A is the valuation over the plurality of sales opportunities (e.g., all of the opportunities within a given phase in the pipeline, or all of the opportunities being managed by a particular salesperson, etc.), Aᵢ is the nominal value of the i^{th} sales opportunity (e.g., the value to the company if the sales opportunity matures into an actual sale), P(φᵢ) is the probability of success associated with the respective sales phase of the i^{th} sales opportunity, Pᵢ is the probability of success associated with the i^{th} sales opportunity, and N is the number of sales opportunities in the plurality of sales opportunities.

In some implementations, the likelihood of success associated with each respective sales opportunity is (620) user-defined.

In some implementations, the device calculates (622) a fourth sum (a so-called “unweighted sum”). The fourth sum is calculated by summing over each sales opportunity in the plurality of sales opportunity. For each respective sales opportunity in the plurality of sales opportunities, the fourth sum includes a monetary amount associated with the respective sales opportunity. For example, the fourth sum may be calculated using the equation:

A=Σᵢ^{N}Aᵢ, (2)

where A is the valuation over the plurality of sales opportunities (e.g., all of the opportunities within a given phase in the pipeline, or all of the opportunities being managed by a particular salesperson, etc.), Aᵢ is the nominal value of the i^{th} sales opportunity (e.g., the value to the company if the sales opportunity matures into an actual sale), and N is the number of sales opportunities in the plurality of sales opportunities.

In some implementations, the device receives (624) a second user input. In response to the second user input, the device displays (626) a second graphical user interface including display of two or more of: information corresponding to the first sum, information corresponding to the second sum, information corresponding to the third sum, and information corresponding to the fourth sum (e.g., as shown in graphical user interface 452, FIG. 4H).

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles of the disclosure and its practical applications, to thereby enable others skilled in the art to best utilize the various implementations with various modifications as are suited to the particular use contemplated.

It will be understood that, although the terms “first,” “second,” etc. are sometimes used herein to describe various elements, these elements should not be limited by these terms. These terms are only used to distinguish one element from another. For example, a first element could be termed a second element, and, similarly, a second element could be termed a first element, without changing the meaning of the description, so long as all occurrences of the “first element” are renamed consistently and all occurrences of the second element are renamed consistently. The first element and the second element are both elements, but they are not the same element.

The terminology used herein is for the purpose of describing particular implementations only and is not intended to be limiting of the claims. As used in the description of the implementations and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, operations, elements, and/or components, but do not preclude the presence or addition of one or more other features, integers, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

Throughout the preceding description, various implementations are described within the context of smart phone cameras, tablets and the like. This is purely for convenience of explanation and is not intended to limit the claims that follow.

What is claimed is:

1. A computer-implemented method, comprising:
displaying a first graphical user interface for customer relationship management that includes a first region corresponding to a first sales phase and a second region corresponding to a second sales phase, wherein the first sales phase is associated with a first progress threshold and the second sales phase is associated with a second progress threshold;
displaying a first representation of a first sales opportunity within the first region, wherein the first representation is associated with a first progress metric of the first sales phase; and
displaying a first indication of the first progress metric with respect to the first progress threshold.

2. The method of claim 1, further comprising:
receiving a first user input; and
in response to the first user input, displaying a second graphical user interface;
wherein the second graphical user interface displays a second indication of the first progress metric with respect to the first progress threshold, the second indication being visually distinct from the first indication.

3. The method of claim 2, wherein the second indication comprises a bar graph.

4. The method of claim 2, wherein the second graphical user interface includes an affordance through which the user defines the first progress threshold.

5. The method of claim 1, further comprising:
receiving a second user input;
in response to the second user input:
moving the first representation from the first region to the second region;
discontinuing display of the first indication of the first progress metric with respect to the first progress threshold; and
displaying a third indication of a second progress metric of the second sales phase with respect to the second progress threshold.

6. The method of claim 2, wherein the second user input is a drag-and-drop user input.

7. The method of claim 1, further comprising:
receiving a third user input; and
in response to the third user input, adding a second representation corresponding to a second sales opportunity to the first region.

8. The method of claim 7, wherein the third user input is a request to copy the first representation.

9. The method of claim 2, wherein:
the first progress metric is a measure of time spent by the first representation in the first region; and
the second progress metric is a measure of time spent by the first representation in the second region.

10. The method of claim 1, wherein the first indication is displayed within or adjacent to the first representation.

11. The method of claim 1, wherein the first indication is color coded such as to be displayed with a first color when the first progress metric is less than the first progress threshold and a second color when the first progress metric is greater than the first progress metric.

12. The method of claim 1, wherein the first sales phase and the second sales phase are user-defined.

13. The method of claim 12, wherein the first progress threshold and the second progress threshold are user-defined.

14. A computer-implemented method, comprising:
calculating a first sum over each sales opportunity in a plurality of sales opportunities, wherein the plurality of sales opportunities includes a first sales opportunity in a first sales phase and a second sales opportunity in a second sales phase, wherein the first sales phase is associated with a first progress threshold and the second sales phase is associated with a second progress threshold, and wherein, for each respective sales opportunity in the plurality of sales opportunities, the first sum includes a product of a monetary amount associated with the respective sales opportunity and a likelihood of success associated with a respective sales phase of the respective sales opportunity, wherein the likelihood of success associated with the first sale phase is different than the likelihood of success of the second sales phase; and
displaying a graphical user interface for customer relationship management, the graphical user interface including a display of information corresponding to the first sum.

15. The method of claim 14, wherein the information corresponding to the first sum is displayed relative to a user-defined goal.

16. The method of claim 14, further comprising:
receiving a first user input;
in response to the first user input:
discontinuing display of the information corresponding to the first sum; and
displaying information corresponding to a second sum, wherein the second sum is calculated by summing over each respective sales opportunity in the plurality of sales opportunities;
wherein, for each sales opportunity in the plurality of sales opportunities, the second sum includes the product of a likelihood of success associated with the respective sales opportunity and a monetary amount associated with the respective sales opportunity.

17. The method of claim 15, further including calculating a third sum;
wherein the third sum is calculated by summing over each sales opportunity in the plurality of sales opportunities; and
wherein, for each respective sales opportunity in the plurality of sales opportunities, the third sum includes the product of a likelihood of success associated with a respective sales phase of the respective sales opportunity, a likelihood of success associated with the respective sales opportunity, and a monetary amount associated with the respective sales opportunity.

18. The method of claim 17, further including calculating a fourth sum;
wherein the fourth sum is calculated by summing over each sales opportunity in the plurality of sales opportunity; and
wherein, for each respective sales opportunity in the plurality of sales opportunities, the fourth sum includes a monetary amount associated with the respective sales opportunity.

19. The method of claim 18, further comprising:
receiving a second user input; and
in response to the second user input, displaying a second graphical user interface including display of two or more of: information corresponding to the first sum, information corresponding to the second sum, information corresponding to the third sum, and information corresponding to the fourth sum.

20. The method of claim 14, the likelihood of success associated with the respective sales phase of each respective sales opportunity is user-defined.

21. The method of claim 15, wherein the likelihood of success associated with each respective sales opportunity is user-defined.
